(19) United States
(12) Patent Application Publication
(10) Pub. No.: US 2001/0000331 A1
(43) Pub. Date: Apr. 19, 2001

(54) Fabrication of a polycarbonate laminate lens having UV curable hard coats

(76) Inventors: Sunder Ram, Petaluma, CA (US); Shi Lin, Petaluma, CA (US)

Correspondence Address: BURNS DOANE SWECKER & MATHIS L L P, POST OFFICE BOX 1404, ALEXANDRIA, VA, 22313-1404, US

(21) Appl. No.: 09/726,970

(22) Filed: Nov. 29, 2000

Related U.S. Application Data
(63) Continuation-in-part of application No. 09/414,991, filed on Oct. 7, 1999.

(51) Int. Cl. B32B 27/00

(52) U.S. Cl. 428/423.1

(57) ABSTRACT

The preparation of a laminated polycarbonate ophthalmic lens with wafers coated with radiation curable coatings is described. The coated wafers are laminated using UV/visible adhesive to produce a finished lens within normal tolerance for such a lens. The wafer also comprises a peelable coating at the interface of laminating surface.

1. This application is a continuation-in-part of U.S. application Ser. No. 09/414,991, filed on Oct. 7, 1999 which is incorporated herein by reference.

### FIELD OF THE INVENTION

2. The invention relates to the fabrication of a polycarbonate ophthalmic lens by laminating wafers. The polycarbonate wafers coated with UV curable coatings on both surfaces are laminated using UV/visible adhesive. The invention also relates to a peelable coating at the bonding surface.

### BACKGROUND OF THE INVENTION

3. Ophthalmic lenses are formed from glass or plastics. Plastics include, for example, polycarbonates and/or polymers based on allyl diglycolcarbonate monomers. Ophthalmic lenses are formed as a single integral body or as laminated lenses that are fabricated by bonding two lens wafers (i.e., a front wafer and a back wafer) together with a UV transparent adhesive. Laminated lens wafers are described, for example, in U.S. Pat. Nos. 5,149,181 and 4,645,317.

4. The laminate construction enables assembly of composite lenses having any of a large number of different combinations of optical corrections from a relatively small stock of prefabricated lens wafers of different configurations. Pairing of different combinations of a front surface lens wafer with a back surface lens wafer can, for example, provide composite lenses having any of large number of different powers as the power of the lens is the summation of the powers of the two wafers.

5. Lens wafers are often coated with a protective polymer composition which also provides means to clean the wafer surface. For example, U.S. Pat. No. 5,883,169 describes lens wafers that are coated with a solvent based removable film. Upon removal of the peelable protective film from the lens surface, contaminants encapsulated with the film are effectively removed from the surface. Lens wafers are also coated with a thin polymeric scratch resistance (hard) coating that is applied to the wafer surfaces prior to formation of the peelable protective film.

6. Prior art hard coatings suffer from a number of disadvantages that adversely affect their performance and ultimately the quality of ophthalmic lenses. It is known that plastic lenses, particularly polycarbonates, have poor scratch resistance. This makes it extremely difficult to fabricate a wafer for lamination without hard coatings on both surfaces. Among other things, prior art hard coats often did not exhibit good adhesion to antireflection coatings or was incompatible with the UV curable transparent adhesives or with the removable protective coat.

### BRIEF DESCRIPTION OF THE DRAWINGS

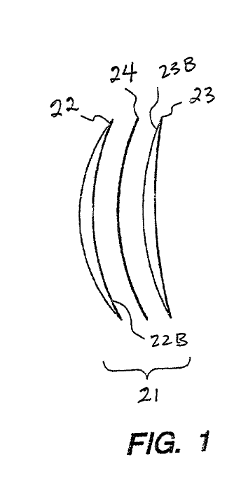

7. FIG. 1 is a cross-sectional view of a laminated lens.

### SUMMARY OF THE INVENTION

8. The present invention is based in part on the development of a novel UV curable composition that is particularly suited for coating plastic ophthalmic lenses. The film developed from the cured composition provides superior abrasion and impact resistance as well as protection against environmental and chemical agents. In addition, the UV curable compositions are capable of forming films on various substrates. The film exhibits excellent compatibility with (1) protective peelable films, (2) transparent adhesives that are employed to laminate lens wafers, and (3) antireflection (AR) coatings. No primer coating is required.

9. In one aspect, the invention is directed to a light transmitting plastic wafer for use in fabricating a laminated lens, said wafer having an optical surface and a bonding surface which can be bonded to the surface of a second wafer by a transparent adhesive during fabrication of said laminated lens, wherein

10. (a) said optical surface is coated with a first multilayer that includes:

11. (1) a first abrasion resistant coating on said optical surface wherein the coating is formed by radiation curing a layer of a first composition on the optical surface; and

12. (2) an anti-reflection coating that is formed on the first abrasion resistant coating; and

13. (b) said bonding surface is coated with a second multilayer that includes:

14. (1) a second abrasion resistant coating on said bonding surface wherein the coating is formed by radiation curing a layer of a second composition; and

15. (2) self-supporting removable film that is formed on the second abrasion resistant coating, wherein the first and second compositions each includes:

16. (i) 20% to 90% of an acrylated aliphatic urethane;

17. (ii) 5% to 75% of a functionalized colloid silica;

18. (iii) 1% to 20% of a photoinitiator; and

19. (iv) a solvent, wherein the percentages are by weight.

20. In another aspect, the invention is directed to a method of fabricating a light transmitting plastic wafer for use in fabricating a laminated lens, said wafer having an optical surface and a bonding surface which can be bonded to the surface of a second lens wafer component by a transparent adhesive during fabrication of said laminated lens, wherein the method includes the steps of:

21. (a) providing a plastic wafer;

22. (b) forming a first multilayer coating on the optical surface of the plastic wafer by:

23. (1) applying a first radiation curable composition onto the optical surface;

24. (2) curing the first composition to form a first abrasion resistant coating; and

25. (3) forming an anti-reflection coating on the first abrasion resistant coating;

26. (c) forming a second multilayer coating on the bonding surface of the plastic wafer by:

27. (1) applying a second radiation curable composition onto the bonding surface; and

28. (2) curing the second composition to form a second abrasion resistant coating; and

29. (d) forming self-supporting removable film on the second abrasion resistant coating, wherein the first and second compositions each includes:

30. (1) 20% to 90% of an acrylated aliphatic urethane;

31. (2) 5% to 75% of a functionalized colloidal metal oxide;

32. (3) 1% to 20% of a photoinitiator; and

33. (4) a solvent, wherein the percentages are by weight

34. In a further aspect, the invention is directed to a method of fabricating a laminated lens that includes the steps of:

35. (a) providing a front plastic wafer having a first optical side and a first bonding side wherein (1) said first optical surface is coated with a first multilayer that includes:

36. (i) a first abrasion resistant coating on the first optical surface wherein the coating is formed by radiation curing a layer of a first composition;

37. (ii) an anti-reflection coating that is formed on the first abrasion resistant coating; and

38. wherein (2) said first bonding surface is coated with a second multilayer that includes:

39. (i) a second abrasion resistant coating on first bonding surface wherein the coating is formed by radiation curing a layer of a second composition; and

40. (ii) first self-supporting removable film;

41. (b) providing a back plastic wafer having a second optical side and a second bonding side wherein (1) said second optical surface is coated with a third multilayer that includes:

42. (i) a third abrasion resistant coating on a second optical surface wherein the coating is formed by radiation curing a layer of a third composition; and

43. (ii) an anti-reflection coating that is formed on the abrasion resistant coating; and

44. wherein (2) said second bonding surface is coated with a fourth multilayer that includes:

45. (i) a fourth abrasion resistant coating on the second bonding surface wherein the coating is formed by radiation curing a layer of a fourth composition; and

46. (ii) a second self-supporting removable film, wherein the first, second, third, and fourth compositions each includes: 20% to 90% of an acrylated aliphatic urethane; 5% to 75% of a functionalized colloidal silica; 1% to 20% of a photoinitiator; and a solvent, wherein the percentages are by weight;

47. (c) removing the first self-supporting removable film from the first plastic wafer thereby exposing a surface of the second abrasion resistant coating on the first bonding surface of the first plastic wafer;

48. (d) removing the second self-supporting removable film from the second plastic wafer thereby exposing a surface of the fourth abrasion resistant coating on the second bonding surface of the second plastic wafer; and

49. (e) laminating the first and second wafers by attaching the first bonding surface of the first wafer to the second bonding surface of the second wafer with a transparent adhesive.

### DETAILED DESCRIPTION OF THE INVENTION

50. The invention is based in part on the development of a UV curable composition that forms durable, abrasion resistant hard coatings that are particularly suited for coating plastic articles such as polycarbonate lens wafers. The radiation curable compositions typically comprise: (a) 20% to 90% of an acrylated aliphatic urethane; (b) 5% to 75% of a functionalized colloidal silica; (c) 1% to 20% of a photoinitiator; and (d) a solvent, wherein the percentages are by weight. Typically, for plastic ophthalmic lenses, the hard coating may be about 1 μm to about 15 μm thick and preferably about 1.5 μm to about 8 μm thick. The thickness of the polymeric scratch resistance coating will depend, in part, on the substrate material.

51. The hard coating exhibits excellent compatibility to other films and components that are employed with lens wafers and laminated lenses. In particular, a peelable protective film can be readily applied to a hard coated lens wafer. In addition, the hard coating can be laminated with a transparent UV curable adhesive to form a laminated lens after removing a peelable protective film. Finally, antireflection coatings can also be readily applied to the hard coating. The hard coating of the present invention does not require a primer layer or other surface pretreatment prior to its formation on the lens wafer surface nor is an adhesion layer or surface treatment of the hard coating needed prior to formation of an antireflection layer thereon.

52. FIG. 1 illustrates laminated lens 21 being fabricated from front lens wafer 22 and back lens wafer 23. A transparent adhesive 24 is situated between inner (concave) surface 22B of front lens wafer 22 and outer (convex) surface 23B of back lens wafer 23. Both surfaces 22B and 23B have a hard coating and a protective film. The protective film is peeled off from inner lens surface 22B and outer lens surface 23B, which are referred to as the interface or bonding surfaces before the lens wafers are laminated together with the transparent adhesive. (The other two surfaces of the two lens wafers that are not laminated together but which are exposed are commonly referred to as the optical surfaces.) Typically, the concave and convex sides of both lens wafers are coated by conventional methods such as, for example, spinning, dipping, spraying, and the like. No surface pretreatment of the lens wafer surface or creation of an adhesive layer on the wafer prior to coating is required. Spin coating is particularly preferred because it creates a uniform film which when cured is relatively defect free. Radiation curable compositions are desirable because of their high productivity and long pot life.

53. This invention is based in part on the discovery that UV curable compositions that employ acrylated aliphatic urethanes and functionalized metal oxides, e.g., functionalized colloidal silica, can produce durable films with improved abrasion resistance and excellent adhesion on plastic substrates. Furthermore, the films are also compatible with anti-reflective coatings.

54. However, prior to describing the invention is further detail, the following terms will be defined:

55. The term “acrylated aliphatic urethane” refers to multifunctional aliphatic acrylated urethanes wherein the acrylic or methacrylic groups provide the reactive functionality. The acrylated aliphatic urethane contains at least 2 and preferably from 3 to 9 polymerizable unsaturated groups, i.e., carbon-carbon double bonds per molecule. The acrylated aliphatic urethane typically has an average molecular weight of about 500 to 1600 Dalton and preferably of about 900 to 1100 Dalton. Suitable aliphatic acrylated urethanes are synthesized, for example, by known reactions between hydroxy multifunctional acrylates and aliphatic diisocyanates. These reactions are described in “Szycher's Handbook of Polyurethane's” Ch. 2-5, by Michael Szycher, CRC Press, 1999.

56. The coating compositions most preferably comprises hexafunctional aliphatic acrylated urethanes. The hexafunctional aliphatic acrylated urethanes, for example, are available as CN 968 from Sartomer Company, Inc. and EBECRYL 1290 and 8301 from UCB Chemicals. Typically, the amount of acrylated aliphatic urethane present in the radiation curable composition ranges from about 20% to 90% and preferably from about 35% to 75%. (All percentages herein are based on weight.)

57. The term “functionalized colloidal metal oxide” refers to metal oxide particles in acrylates or organic solvents. Suitable metal oxides include, for example, silicon oxide. Typically the metal oxide particles have diameters that range from 2 μm to 60 μm and preferably from 5 μm to 50 μm. Suitable functionalized colloidal silica include acrylic and methacrylic based silica organols that are commercially available, for example, as HIGHLINK OG108-32 and OG100-31 from Clariant Corporation, MEK-ST and IPA-ST from Nissan Chemical, and FCS 100 from General Electric Company. The HIGHLINK OG108-32 is a liquid suspension of colloidal silica in tripropylene glycol diacrylate. Partially hydrolyzed alkoxysilylacrylates such as acryloxypropyltrimethoxysilane may also be used. Typically, the amount of functionalized colloidal metal oxide present in the radiation curable composition ranges from about 5% to 75% and preferably from about 10% to 60%.

58. The term “photoinitiator” refers to agents that catalyze the polymerization of monomer systems. Suitable photoinitiators include, for example, benzophenone, 1-hydroxycyclohexyl phenyl ketone (methanone), acetophenone, and the like, and mixtures thereof. Methanone is particularly preferred. Typically, the amount of photoinitiator present in the radiation curable composition ranges from about 1% to 20% and preferably from about 3% to 10%.

59. The term “light stabilizer” refers to compounds that enhance the color of the coating by selecting absorbing radiation. Preferred light stabilizers include, for example, substituted benzophenones, benzotriazoles, hindered amines and diphenyl acrylates. A particularly preferred light stabilizer is 2,2′,4,4′-tetrahydroxy benzophenone, available as UVINUL 3050 from BASF Corporation which exhibited excellent compatibility with the acrylated aliphatic urethanes. Typically, when employed, the amount of light stabilizer present in the radiation curable composition ranges from about 1% to 20% and preferably from about 2% to 8%.

60. The term “flow additive” refers to materials that enhance the rheology of the radiation curable composition. Acrylic or silicone containing surface additives are the preferred flow additives, e.g., BYK 371, BYK 358, both from BYK-Chemie USA, and FC430 from 3M Company. Typically, when employed, the amount of flow additive present in the radiation curable composition ranges from about 0.05% to 5% and preferably from about 0.1% to 1%.

61. The term “lens wafer” or wafer” refers to an ophthalmic lens wafer which has superior structural and optical properties. Plastics, including polycarbonates such as LEXAN, available from General Electric Co., are preferred lens wafer materials. Preferred ophthalmic lenses (including sunglasses) also include laminated lenses that are fabricated by bonding two lens wafers (i.e., a front wafer and a back wafer) together with a transparent adhesive. Laminated lens wafers are described, for example, in U.S. Pat. Nos. 5,149,181, and 4,645,317 and U.K. Patent Application, GB 2,260,937A, all of which are incorporated herein.

62. The term “anti-reflection coating” or “AR coating” refers to a substantially transparent multilayer film that is applied to optical systems (e.g., surfaces thereof) to substantially eliminate reflection over a relatively wide portion of the visible spectrum, and thereby increase the transmission of light and reduce surface reflectance. Known anti-reflection coatings include multilayer films comprising alternating high and low refractive index materials (e.g., metal oxides) as described, for instance, in U.S. Pat. Nos. 3,432,225, 3,565,509, 4,022,947, and 5,332,618, all of which are incorporated herein. AR coatings can also employ one or more electrically conductive high and/or electrically conductive low refractive index layers which are further described in U.S. Pat. No. 5,719,705 which is incorporated herein by reference. The thickness of the AR coating will depend on the thickness of each individual layer in the multilayer film and the total number of layers in the multilayer film. Preferably, the AR coating for the ophthalmic lens has about 3 to about 12 layers. Preferably, the AR coating is about 100 to about 750 nm thick. For use with ophthalmic lenses, the AR coating is preferably about 220 to about 500 nm thick.

63. Finally, a single-layer or multi-layer anti-reflective coatings can be formed on the above mentioned coating layer. Examples of materials useful in forming anti-reflective coatings include metal oxides such as SiO, SiO₂, ZrO₂, CrO₂ and TiO₂ and fluorides such as MgF₂. These inorganic anti-reflective coatings can be single-layer systems, but more generally are multi-layer anti-reflective stacks deposited by vacuum evaporation, deposition, sputtering, ion plating, and/or ion bean assisted methods.

64. The term “solvent” is meant to include a single solvent or a mixture of solvents that dissolve the acrylated aliphatic urethane and photoinitiator so that the to coating composition can be readily applied. Particularly preferred solvents include, for example, methyl ethyl ketone, acetone, methyl isobutyl ketone, methyl propyl ketone, cyclohexanone, cyclopentanone, butyrolactone, methanol, ethanol, isopropanol, butanol, tetrahydrofuran, N-methyl pyrrolidone, tetrahydrofurfural alcohol, and mixtures thereof. Ketones are particularly preferred because they exhibit excellent solubility of the acrylated aliphatic urethane and photoiniator.

65. The amount of solvent used will depend on, among other things, the particularly components employed to formulate the coating composition, the temperature of the coating composition, the coating thickness, and the coating technique to be used. Typically, the solvent will comprise from about 5% to 80% of the coating composition. For spin coating application, the solvent will preferably range from about 20% to 70% of the coating composition.

66. The term “peelable protective film” refers to a self-supporting removable film formed on the surface of a hard coated plastic lens wafer. Preferably the film does not cross-link to the hard coated wafer surface and provides an effective method to clean the surface of the lens. The self-supporting removable film is prepared a process which comprises: (a) applying a film forming composition onto a surface of the lens wafer, wherein the composition comprises: (i) a film forming unmodified polymers, and (ii) a compatible solvent; and (b) removing said solvent to form the removable film that coats the surface without being cross-linked thereto. Peelable protective films are further described in U.S. Pat. No. 5,883,169 which is incorporated herein by reference.

67. Preferred film forming unmodified polymer for the protective film refers to a polymer or mixture of polymers, including copolymers, that are soluble or suspendable in a compatible solvent such that upon removal of the solvent a film is formed on the surface to which the polymer solution or suspension was applied and which polymers do not contain sufficient functional groups (and preferably no functional groups) so as to result in cross-linking of the polymer to the lens wafer surface. Cross-linking of the polymer to the lens wafer surface refers to covalent or ionic binding of functional groups on the polymer to complementary functional groups found on the surface of the wafer.

68. In a preferred embodiment, the film forming unmodified polymer comprises a copolymer of vinyl chloride and vinyl acetate. More preferably, the copolymer of vinyl chloride and vinyl acetate comprises from about 75% to about 98% vinyl chloride and from 2% to 25% vinyl acetate. In still a more preferred embodiment, such copolymers have a molecular weight of from 15,000 to about 70,000 Dalton. The film forming unmodified polymers, for example, are available as UCAR solution Vinyl Resin VYHH and VYNS-3 from Union Carbide Chemicals and Plastics Co.

69. The film forming composition described above can optionally contain additives such as anti-static agents, plasticizers, anti-oxidants, etc. Suitable plasticizers include, for example, dipropylene glycol dibenzoate, butyl benzyl phthalate, diethylene glycol dibenzoate, and the like. Dipropylene glycol dibenzoate is commercially available as BENZOFLEX 9-88 from Velsical Chemical Corp. When employed, plasticizers are present at from about 20% to about 30% by weight based on total solids content. Suitable anti-static agents include, for example, GLYCOLUBE AFA (available from Lonza, Inc.), glycerol monleate, polyoxyethylene sorbitan monooleate, and the like. When employed, anti-static agents are present at about 0.1% to about 5% by weight based on total solids content.

70. The term “transparent adhesives” refers to adhesives suitable for bonding lens wafers together which adhesives are optically transparent in the visible light portion of the spectrum. Transparent adhesives are described in U.S. Pat. Nos. 5,149,181, and 4,645,317 and British Patent Application number 2,260,937A. The particular transparent adhesive employed herein is not critical but preferably is a UV curable adhesive sold under the trade name MULTI-CURE 492 available from Dymax, Inc.

### FORMULATION OF COATING COMPOSITION

71. The radiation curable coating composition is preferably formulated by blending together the acrylated aliphatic urethane, functionalized colloidal metal oxide, and photoinitiator in a suitable organic solvent. Optional components such as the light stabilizer and/or flow additive, e.g., BYK 371, FC 430, etc., can also be added at this stage.

72. The curable coating compositions can be applied to lens wafers or other substrates by conventional coating methods such as, for example, spinning, dipping, spraying and the like. No surface pretreatment of the substrate surface or creation of an adhesive layer on the substrate prior to coating is required. Spin coating is particularly preferred because it creates a uniform film which when cured is relatively defect free. The thickness of the coating of curable coating composition that is applied will depend on the particular substrate and application. In the case of ophthalmic plastic lenses the thickness of the film should be sufficient so that when the composition is cured, the hard coating layer should have a final thickness that ranges from about 1 to about 15 μm and preferably from about 1.5 to about 8 μm. Thicker hard coating layers can lead to crazing and other defects over time, however, thinner layers often do not provide enough surface material to be scratch resistant. Additionally, it is often advantageous to have a hard coating layer that is thick enough to cover minor blemishes on the surface of the lens.

73. The curable coating compositions can be cured by radiation, e.g., UV radiation. Sources of UV radiation include, for example, plasma arc discharges, mercury vapor lamps, etc. A preferred source of UV irradiation is a Fusion 300 watt/in H lamp.

74. Following the curing step, a peelable protective film can be formed on the interface sides of the lens wafers. This film is removed just prior to lamination to keep the interface lens surface clean. Finally, if desired an anti-reflective coating can be formed on the hard coating layer. No surface pretreatment of the protective layer or creation of an adhesive layer thereon is needed.

### EXPERIMENTAL

75. Examples 1-5 describe the preparation of hard coating resin compositions that were used to form abrasion resistant films on polycarbonate lens. The lens were then subject to various physical tests which demonstrated that the film were durable. In addition, the films exhibited good compatibility to anti-reflective coatings.

### EXAMPLES 1-5

76. In Examples 1-5, commercially available finished polycarbonate ophthalmic lens wafers were coated with an abrasion resistant coating. Specifically, lenses were coated five different formulations of the coating composition that contained (1) an acrylated aliphatic urethane, (2) a functinalized colloidal silica, (3) photoinitiator (i.e., 1-hydroxycyclohexyl phenyl ketone), and (4) methyl isobutyl ketone (MIBK). In formulating the coating compositions, the acrylated aliphatic urethane and colloidal silica were initially dissolved in the MIBK and mixed for 2 hours. Thereafter, the photoinitiator was added to the mixture which was mixed for a short duration before being used. The serial mixing time was 30 minutes. The thickness of the cured hard coating was about 5 μm. Finally, an anti-reflective coating was applied to the hard coating using a vacuum deposition process to deposit a multi-layer anti-reflective film on the optical surfaces of the lens wafers. Each film had 5 layers comprising alternating layers of titanium oxide and silicon oxide, with silicon oxide being the first, third and fifth layers.

77. The relative amounts (parts) of the acrylated aliphatic urethane and colloidal silica in the five formulations are set forth in Table 1. The compositions contained 100 parts of MIBK and 5 parts of photoinitiator.

TABLE 1

| Sample | Acrylated aliphatic Urethane | Functionalized Colloidal Silica |
|---|---|---|
| 1 | CN 968 (75) | HIGHLINK OG 108-32 (20) |
| 2 | EBECRYL 1290 (75) | HIGHLINK OG 108-32 (20) |
| 3 | EBECRYL 8301 (75) | HIGHLINK OG 108-32 (20) |
| 4 | CN 968 (75) | FCS 100 (20) |
| 5 | CN 968 (35) | HIGHLINK OG 108-32 (60) |

78. The results of the tests are set forth in Table 2.

TABLE 2

| Sample Adhesion | Hot Water | Salt Water Boil | Bayer | Steel Wool |
|---|---|---|---|---|
| 1 100/100 | Pass | Pass | 2.8 | 3 |
| 2 100/100 | Pass | Pass | 2.6 | 3 |
| 3 100/100 | Pass | Pass | 2.6 | 3 |
| 4 100/100 | Pass | Pass | 2.5 | 4 |
| 5 100/100 | Pass | Pass | 3.2 | 4 |

79. The test procedures were as follows:

### Adhesion Test

80. The cross-cut tape test, where 6 parallel lines each in two perpendicularly crossing directions are cut with a six blade cutter, was employed. The lines are cut at fixed intervals of approximately 1 mm on the surface of the coating of a given sample to produce a total of 49 squares. Thereafter, adhesive cellophane tape is applied to the cut squares, the tape is peeled, and the squares on which the coat film are counted. The adhesion is measured by the number of squares remaining.

### Hot Water Resistance Test

81. A hard coated sample (without an AR coating) was placed in boiling water for totally three hours. The adhesion test was applied to the sample each hour.

### Salt Water Boil Test for AR Coated Lenses

82. AR coated lenses go through 6 cycles in this test. In each cycle, the samples were submerged in boiling salt water for 2 minutes, then they were removed to distilled water (18-20° C.) for at least 1 minute. The lenses were checked for crazing and detachment after each cycle. The adhesion test was also applied to the sample after 6 cycles.

### Abrasion Resistance (Bayer) Test

83. A Bayer Sand Abrasion Tester was used. The samples, alone with a control sample of uncoated CR-39 lens, were abraded by an oscillating abrasive material (500 grams of aluminum zirconium oxide, grid size 12), over a 4 inch stroke at a rate of 150 cycles per minute for a total of 300 cycles. The increase in haze of the samples was measured by a hazemeter and normalized against a control lens abraded during the same test. The result is the Bayer value, defined by an abrasion ratio of control lens to the sample lens. Therefore, the Bayer value for uncoated CR-39 is 1.0. The Bayer value reported here is the average of three samples.

### Steel Wool Resistance Test

84. A proprietary and automated scrubber having a steel wool #0 surface was utilized. Each sample was scrubbed 75 cycles with the steel wool under 2 kilograms load. Thereafter, abrasion was detected by visual inspection and graded in accordance with the 1-5 scale: 5-Best, 1-Worst.

### EXAMPLE 6

85. In this example, peelable protective films were formed on polycarbonate lens wafers that were coated with a hard coating developed from Example 1. The peelable protective film was prepared from a composition that included (1) 73.5 parts of an unmodified polymer (VTHH), (2) 25.0 parts of dipropylene glycol dibenzoate (DGD) (BENZOFLEX 9-88), (3) 1.50 parts of an anti-static agent (GLYCOLUBE AFA-1) and (4) 233.3 parts of acetone. The polymer composition was prepared by slowly adding the unmodified polymer into acetone under agitation at room temperature, mixing for one hour, then adding the DGD, and finally adding the anti-static agent. The composition was applied onto the hard coated lens surface by spin coating and allowed to dry at ambient conditions to form a solid film on the hard coated lens. The film was about 10 μm thick.

86. The peelable protective film was removed by attaching adhesive tape to an edge region of the lens surface and withdrawing the tape from the surface to peel off the film. The film exhibited good peelability and cleaning effectiveness as it was able to remove surface dust and grease-based contaminants (e.g. fingerprints) without breaking up.

### EXAMPLE 7

87. In this example, a silicone based hard coating developed from TS-56-HF, which is a commercially available silicone mixture from Tokuyama Corporation, Japan, was applied on the optical surface of hard coated lens as prepared in the manner described in Example 1. The adhesion of the silicone based hard coating to the underlying UV curable hard, coating was excellent. In addition, AR coatings were also formed on the silicone based hard coating adhered well thereto.

### EXAMPLE 8

88. The front and rear polycarbonate lens wafers were coated with a hard coating and a peelable protective films as described in Example 6. After removing the protective films from the bonding surfaces, a transparent adhesive, MULTICURE 492 from Dymax, Inc., was applied to the interface surfaces of the front and rear lens wafers before the lens wafers were pressed together. The adhesive was allowed to cured thereby bonding the lens wafers together to form a laminated lens. The lens wafers of the laminated lens demonstrated good adhesion.

89. Although only preferred embodiments of the invention are specifically disclosed and described above, it will be appreciated that many modifications and variations of the present invention are possible in light of the above teachings and within the purview of the appended claims without departing from the spirit and intended scope of the invention.

What is claimed is:

1. A light transmitting plastic wafer for use in fabricating a laminated lens, said wafer having an optical surface and a bonding surface which can be bonded to the surface of a second wafer by a transparent adhesive during fabrication of said laminated lens, wherein
(a) said optical surface is coated with a first multilayer that comprises:
(1) a first abrasion resistant coating on said optical surface wherein the coating is formed by radiation curing a layer of a first composition on the optical surface; and
(2) an anti-reflection coating that is formed on the first abrasion resistant coating; and wherein
(b) said bonding surface is coated with a second multilayer that comprises:
(1) a second abrasion resistant coating on said bonding surface wherein the coating is formed by radiation curing a layer of a second composition; and
(2) self-supporting removable film that is formed on the second abrasion resistant coating, wherein the first and second compositions each comprises:
(i) 20% to 90% of an acrylated aliphatic urethane;
(ii) 5% to 75% of a functionalized colloid silica;
(iii) 1% to 20% photoinitiator; and
(iv) a solvent, wherein the percentages are by weight.

2. The wafer of claim 1 wherein for the first and second compositions the acrylated aliphatic urethane has a molecular weight of between 500 to 1600 Dalton.

3. The wafer of claim 1 wherein each of the first and second compositions further comprises an effective amount of a light stabilizer.

4. The wafer of claim 1 wherein the first and second compositions further comprise an effective amount of a flow additive.

5. The wafer of claim 1 wherein for the first and second compositions the acrylated aliphatic urethanes comprise at least two polymerizable carbon-carbon double bonds per molecule.

6. The wafer of claim 1 wherein for the first and second compositions the acrylated aliphatic urethanes are hexafunctional urethane acrylates.

7. The wafer of claim 1 wherein for the first and second compositions the functionalized colloidal metal oxides are acrylic or methacrylic based silica organosol.

8. The wafer of claim 1 characterized in that there is no adhesion layer between the first resistant coating and optical surface or between the second abrasion resistant coating and bonding surface.

9. The wafer of claim 1 further comprising a hard coating situated between the first abrasion resistant layer and the anti-reflection layer.

10. The wafer of claim 1 wherein the wafer is an ophthalmic lens wafer.

11. The wafer of claim 1 wherein each abrasion resistant coating has a thickness of about 1 μm to 15 μm.

12. The wafer of claim 1 wherein the wafer is made of polycarbonates.

13. A method of fabricating a light transmitting plastic wafer for use in fabricating a laminated lens, said wafer having an optical surface and a bonding surface which can be bonded to the surface of a second lens wafer component by a transparent adhesive during fabrication of said laminated lens, wherein the method comprises the steps of:
(a) providing a plastic wafer;
(b) forming a first multilayer coating on the optical surface of the plastic wafer by:
(1) applying a first radiation curable composition onto the optical surface;
(2) curing the first composition to form a first abrasion resistant coating;
(3) forming an anti-reflection coating on the first abrasion resistant coating; and
(c) forming a second multilayer coating on the bonding surface of the plastic wafer by:
(1) applying a second radiation curable composition onto the bonding surface; and
(2) curing the second composition to form a second abrasion resistant coating; and
(3) forming self-supporting removable film on the second abrasion resistant coating, wherein the first and second compositions each comprises:
(1) 20% to 90% of an acrylated aliphatic urethane;
(2) 5% to 75% of a functionalized colloidal metal oxide;
(3) 1% to 20% of a photoinitiator; and
(4) a solvent, wherein the percentages are by weight.

14. The method of claim 13 wherein for the first and second compositions the acrylated aliphatic urethane has a molecular weight of between 500 to 1600 Dalton.

15. The method of claim 13 the first and second compositions further comprise an effective amount of a light stabilizer.

16. The method of claim 13 the first and second compositions further comprise an effective amount of a flow additive.

17. The method of claim 13 wherein for the first and second compositions the acrylated aliphatic urethane comprises at least two polymerizable carbon-carbon double bonds per molecule.

18. The method of claim 13 wherein for the first and second compositions the acrylated aliphatic urethane is a hexafunctional urethane acrylate.

19. The method of claim 13 wherein for the first and second compositions the functionalized colloidal metal oxide is an acrylic or methacrylic based silica organosol.

20. The method of claim 13 characterized in that the there is no adhesion layer between the first abrasion resistant coating and optical surface or between the second abrasion resistant coating and bonding surface.

21. The method of claim 13 further comprising forming a hard coating situated between the first abrasion resistant layer and the anti-reflection layer.

22. The method of claim 13 wherein the steps of curing the compositions comprise exposing the compositions to UV radiation.

23. The method of claim 13 wherein the wafer is an ophthalmic lens wafer.

24. The method of claim 13 wherein each abrasion resistant coating has a thickness of about 1 μm to 15 μm.

25. The method of claim 13 wherein the wafer is made of polycarbonates.

26. A method of fabricating a laminated lens that comprises the steps of:
(a) providing a front plastic wafer having a first optical side and a first bonding side wherein (1) said first optical surface is coated with a first multilayer that comprises:
(i) a first abrasion resistant coating on the first optical surface wherein the coating is formed by radiation curing a layer of a first composition; and
(ii) an anti-reflection coating that is formed on the first abrasion resistant coating; and
wherein (2) said first bonding surface is coated with a second multilayer that comprises:
(i) a second abrasion resistant coating on first bonding surface wherein the coating is formed by radiation curing a layer of a second composition; and
(ii) first self-supporting removable film;
(b) providing a back plastic wafer having a second optical side and a second bonding side wherein (1) said second optical surface is coated with a third multilayer that comprises:
(i) a third abrasion resistant coating on a the second optical surface wherein the coating is formed by radiation curing a layer of a third composition;
(ii) an anti-reflection coating that is formed on the abrasion resistant coating; and
wherein (2) said second bonding surface is coated with a fourth multilayer that comprises:
(i) a fourth abrasion resistant coating on the second bonding surface wherein the coating is formed by radiation curing a layer of a fourth composition; and
(ii) second self-supporting removable film, wherein the first, second, third, and fourth compositions each comprises: 20% to 90% of an acrylated aliphatic urethane; 5% to 75% of a functionalized colloid silica; 1% to 20% of a photoinitiator; and a solvent, wherein the percentages are by weight;
(c) removing the first self-supporting removable film from the first plastic wafer thereby exposing a surface of the second abrasion resistant coating on the first bonding surface of the first plastic wafer;
(d) removing the second self-supporting removable film from the second plastic wafer thereby exposing a surface of the fourth abrasion resistant coating on the second bonding surface of the second plastic wafer; and
(e) laminating the first and second wafers by attaching the first bonding surface of the first wafer to the second bonding surface of the second wafer with a transparent adhesive.

27. The method of claim 26 wherein for the first, second, third, and fourth compositions the acrylated aliphatic urethane has a molecular weight of between 500 to 1600 Dalton.

28. The method of claim 26 the first, second, third, and fourth compositions further comprise an effective amount of a light stabilizer.

29. The method of claim 26 the first, second, third, and fourth compositions further comprise an effective amount of a flow additive.

30. The method of claim 26 wherein for the first, second, third, and fourth compositions the acrylated aliphatic urethane comprises at least two polymerizable carbon-carbon double bonds per molecule.

31. The method of claim 26 wherein for the first, second, third, and fourth compositions the acrylated aliphatic urethane is a hexafunctional urethane acrylate.

32. The method of claim 26 wherein for the first, second, third, and fourth compositions the functionalized colloidal metal oxide is an acrylic or methacrylic based silica organosol.

33. The method of claim 26 characterized in that the there is no adhesion layer between the first abrasion resistant coating and first optical surface, between the second abrasion resistant coating and first bonding surface, between the third abrasion resistant coating and second optical surface, or between the fourth abrasion resistant coating and second bonding surface.

34. The method of claim 26 further comprising forming a hard coating between the first abrasion resistant layer and the anti-reflection layer.

35. The method of claim 26 wherein the steps of curing the compositions comprise exposing the compositions to UV radiation.

36. The method of claim 26 wherein the front and back wafers are ophthalmic lens wafers.

37. The method of claim 26 wherein each abrasion resistant coating has a thickness of about 1 μm to 15 μm.

38. The method of claim 26 wherein the wafers are made of polycarbonates.
